(19) United States
(12) Patent Application Publication
(10) Pub. No.: US 2010/0013809 A1
(43) Pub. Date: Jan. 21, 2010

(54) Scan driver and plasma display device using the same

(76) Inventor: Yoo-Jin Song, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/458,373

(22) Filed: Jul. 9, 2009

(30) Foreign Application Priority Data
Jul. 15, 2008 (KR) 10-2008-0068540

(51) Int. Cl. G09G 5/00; G09G 3/28

(52) U.S. Cl. 345/205; 345/60

(57) ABSTRACT

A scan driver includes a scan driving integrated circuit, a first film on a first surface of the scan driving integrated circuit, the first film including at least one first wire adapted to provide reference potential to the scan driving integrated circuit, and a second film on a second surface of the scan driving integrated circuit, the second surface of the scan driving integrated circuit being opposite the first surface, and the second film including at least one second wire adapted to transfer input and output signals.

### BACKGROUND

1. Field

Example embodiments relate to a scan driver used for driving a plasma display panel, and to a plasma display device using the same.

2. Description of the Related Art

A plasma display device is a display device displaying an image by generating plasma in a discharge space between two substrates opposed to each other. The generated plasma in the discharge space causes phosphor between the two substrates to emit light.

However, when a scan driving integrated circuit (scan IC) in a plasma display device uses a floating reference potential, an abrupt voltage change may occur in the scan IC during a sustain period at the time of driving the panel unit. Abrupt and sudden signal changes, e.g., voltage fluctuations, during a floating state of the scan IC may cause malfunction of the plasma display device, e.g., a defective screen, due to noise generated by the scan IC. Such problems may be increased when the plasma display device uses a single scan IC.

Attempts have been made to use a separate scan buffer board for the scan IC within the driving system of the plasma display device in order to minimize noise. However, since the conventional driving system including the separate buffer board for the scan IC may require 4-layer printed circuit board (PCB) for manufacturing thereof and the valid area of use in the panel display unit may be small, manufacturing costs of the conventional buffer board for the scan IC may be high.

### SUMMARY

Embodiments are therefore directed to a scan driver and to a plasma display device, which substantially overcome one or more of the problems due to the limitations and disadvantages of the related art.

It is therefore a feature of an embodiment to provide a scan driver capable of securing sufficient reference potential and being coupled to a radiating heat system with ease.

It is therefore another feature of an embodiment to provide a plasma display device capable of raising EMI shielding performance and improving operation stability by using the scan driver.

At least one of the above and other features and advantages may be realized by providing a scan driver, including scan driving integrated circuit, a first film having a first wire contacting one surface of the scan driving integrated circuit and providing reference potential to the scan driving integrated circuit, and a second film having a second wire contacting the other surface opposite to the one surface of the scan driving integrated circuit and transferring a signal and an output.

The first film may be coupled to the second film through a connector.

The scan driver may further include a passivation layer surrounding the scan driving integrated circuit between the first film and the second film. The first and second wires may be facing each other.

The scan driver may include a plurality of the second wires, the first wire overlapping the plurality of second wires. A width of the first wire may equal at least half a width of the first film, the widths of the first wire and first film being measured along a direction substantially perpendicular to a longitudinal direction of the first film. The scan driver may further include at least one third wire on the second film, the third wire being adapted to provide reference potential to the scan driving integrated circuit.

At least one of the above and other features and advantages may also be realized by providing a plasma display device, including a panel unit with a pair of substrates opposite to each other, a barrier rib disposed between the substrates and partitioning a discharge space, a scan electrode, a sustain electrode and an address electrode disposed between the substrates and generating discharge in the discharge space, and a phosphor emitting light by the discharge, and a driving unit including a scan driver driving the scan electrode and the sustain electrode and driving the panel unit, wherein the scan driver includes a scan driving integrated circuit, a first film having a first wire contacting one surface of the scan driving integrated circuit and providing reference potential to the scan driving integrated circuit, and a second film having a second wire contacting the other surface opposite to the one surface of the scan driving integrated circuit and transferring a signal and an output.

The plasma display device may further include a base chassis supporting the panel unit and the driving unit. In this case, any one of the first film and the second film is disposed to contact the base chassis.

The first film may be coupled to the second film through a connector.

The plasma display device may further include a passivation layer surrounding the scan driving integrated circuit between the first film and the second film. A width of the first wire may equal at least half a width of the first film, the widths of the first wire and first film being measured along a direction substantially perpendicular to a longitudinal direction of the first film. The scan driver may further include at least one third wire on the second film, the third wire being adapted to provide reference potential to the scan driving integrated circuit.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a schematic cross-sectional view of a scan driver according to embodiments;

FIG. 2A illustrates a plan view of a first film of FIG. 1;

FIG. 2B illustrates a plan view of a second film of FIG. 1;

FIG. 3 illustrates a block diagram of a plasma display device using a scan driver of the embodiments; and

FIG. 4 illustrates a partial cross-sectional view of a scan driver attached to a plasma display device of the embodiments.

### DETAILED DESCRIPTION

Korean Patent Application No. 10-2008-0068540, filed on Jul. 15, 2008, in the Korean Intellectual Property Office, and entitled “Scan Driver and Plasma Display Device Using the Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

FIG. 1 illustrates a schematic cross-sectional view of a scan driver according to an example embodiment.

Referring to FIG. 1, the scan driver may include a scan IC 10, a first film 20, and a second film 30. The first and second films 20 and 30 may be disposed on each side of the scan IC 10, respectively, so the scan IC 10 may be sandwiched between the first and second films 20 and 30. In other words, the scan driver may have a dual junction structure of Chip On Flexible (COF) printed circuit board or Tape Carrier Package (TCP) with respect to the first and second films 20 and 30. The scan driver may further include a passivation layer 40 surrounding the scan IC 10 between the first film 20 and the second film 30. The passivation layer 40 may include, e.g., resin.

The first film 20 and the second film 30 may include a flexible printed circuit board or a tape film adaptable to the COF or TCP junction structure. One of the first film 20 and the second film 30 may have a conductive wire pattern providing a common reference potential to the scan IC 10, and the other of the first film 20 and the second film 30 may selectively have a conductive wire pattern transferring a signal input. A conductive wire pattern for supplying power may be disposed on at least one of the first film 20 and the second film 30.

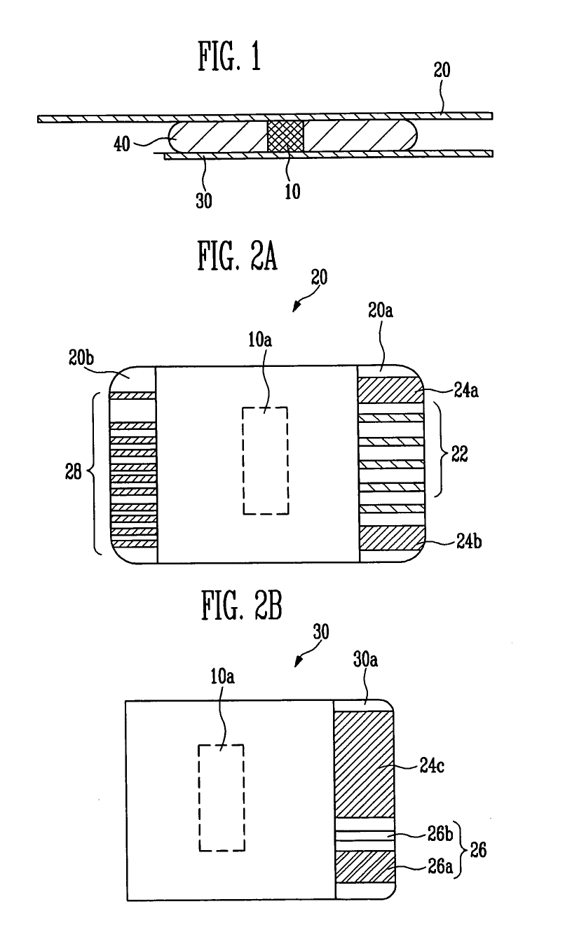

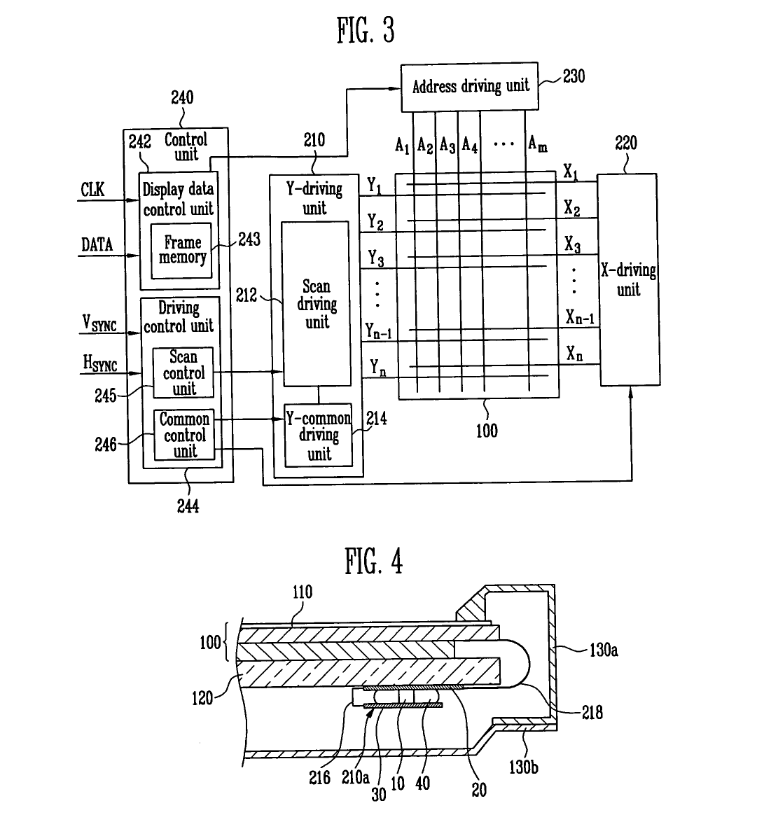

The scan driver according to example embodiments may include an input signal pattern on only one of the first and second films 20 and 30, so the scan driver may have an increased space thereon, i.e., on the other of the first and second films 20 and 30, to obtain freedom in designing the scan driver in which two scan ICs may be simultaneously disposed according to a pitch adjustment of the output signal pattern. The patterns on the first and second films 20 and 30 will be described in more detail below with reference to FIGS. 2A and 2B.

FIG. 2A illustrates a plan view of the first film 20 in FIG. 1. FIG. 2B illustrates a plan view of the second film 30 in FIG. 1.

Referring to FIG. 2A, the first film 20 may have a first pad 20a coupled to a Y-driving unit and a second pad 20b coupled to a plasma display panel. The first and second pads 20a and 20b may be at opposite edges of the first film 20. A portion 10a of the first film 20 may be attached to the scan IC 10, i.e., a portion indicated with a dashed line in FIG. 2A. The portion 10a may be between the first pad 20a and the second pad 20b. For example, the portion 10a may be sufficiently large to overlap an entire surface of the scan IC 10 facing the first film 20, e.g., portion 10a may have a larger surface area than the surface of the scan IC 10 facing the first film 20.

As illustrated in FIG. 2A, a plurality of signal input patterns 22 and first reference potential patterns 24a and 24b may be disposed on the first pad 20a. Signal output patterns 28 may be disposed on the second pad 20b. The scan IC 10 may perform a signal processing operation through the signal input patterns 22, reference potential patterns 24a/24b, and output patterns 28.

Referring to FIG. 2B, the second film 30 may have a third pad 30a. The third pad 30a may be disposed with power supply patterns 26a and 26b coupled to a power supplier and with a second reference potential pattern 24c applied with a common reference potential. The portion 10a, i.e., a region of the second film 30 attached to the scan IC 10, is indicated in FIG. 2B. The second reference potential pattern 24c may be wider than either of the first reference potential patterns 24a/24b. For example, the second reference potential pattern 24c may overlap a plurality of patterns on the first film 20. In another example, a width of the second reference potential pattern 24c may equal at least half a width of the second film 30, e.g., the widths of the second reference potential pattern 24c and second film 30 may be measured along a direction substantially perpendicular to a longitudinal side of the second film 30.

The scan IC 10 may be positioned to overlap, e.g., completely overlap, with portion 10a of each of the first and second films 20 and 30, so the first and second films 20 and 30 may be parallel to each other. For example, the first and second films 20 and 30 may be positioned so the first pad 20a may overlap the third pad 30a, e.g., the first or second reference potential pattern 24a or 24b on the first film 20 may face the second reference potential pattern 24c on the second film 30. Furthermore, as further illustrated in FIGS. 1 and 2A-2B, the first film 20 may be longer than the second film 30 along a horizontal direction, i.e., a longitudinal direction of the second film 30, so the second pad 20b may not overlap the second film 30.

As described above with reference to FIG. 1, the scan driver according to example embodiments may include reference potential patterns on both first and second films 20 and 30, thereby substantially increasing the operation stability of the scan IC 10. In particular, since a total area of pads of the first and second films 20 and 30, i.e., first, second, and third pads 20a, 20b, and 30a, may be larger than a total area of pads of a scan driver having a single film, reference potential patterns formed on the pads of the first and second films 20 and 30 may be larger, thereby making it possible to reduce impedance in the circuit terminal. In other words, since the reference potential patterns according to example embodiments may be formed on a larger area, reference potential applied to the scan IC 10 may be more stable. Furthermore, the scan driver according to example embodiments may have a sufficiently stable reference potential and may prevent or substantially minimize malfunction due to noise, while more signal inputs may be applied to the scan driver.

In contrast, in a comparative example a driver may include a single film on a driving IC, so all the input/output patterns, power patterns, and reference potential patterns may be formed on the single film, thereby having a reduced area available for reference potential patterns. Further, in another comparative example, even if a non-data IC driver having reference potential patterns fixed to ground GND to facilitate a stable operation, e.g., reduced noise when input signals and/or output signals are abruptly changed, is adapted as a data driver IC of a plasma display device, it may be difficult to use the driver as a scan driver.

Furthermore, in another comparative example, a scan IC may include two transistors coupled in series and a control terminal driving the two transistors. In this case, the scan IC may be applied with voltages from the highest voltage having positive (+) voltage of several hundred volts to the lowest voltage having negative (−) voltage of several hundred volts. Since the reference potential, i.e., a source terminal of the transistor, may be fixed to ground voltage 0V, the voltage applied to the scan IC may almost double, so it may be almost impossible for the driver to operate as a scan driver normally.

In order to operate the scan IC normally, it may be required that a voltage difference between gate and source having the source terminal of the transistor be set as the reference potential, rather than the operation voltage having the ground voltage be set as the reference potential. Therefore, in example embodiments, a reference voltage of the scan IC may be set as Out_1 voltage, i.e., an output voltage of a scan low transistor inside the scan IC. The Out_1 voltage may be variable according to an applied voltage of the driving circuit of the plasma display device, so the reference potential of the scan IC may be floated.

A scan driver according to example embodiments may have a dual junction structure, so the scan IC 10 may be sandwiched between the first and second films 20 and 30. Use of the first and second films 20 and 30 on two opposing surfaces of the scan IC 10 may increase a total area of film, e.g., a total area of film pads, on the scan IC 10, so the scan driver may have increased width of the reference potential patterns without increasing a total area of a single film on the driver IC 10. Therefore, the scan driver may give sufficient reference potential to the scan IC 10, thereby making it possible to improve operation stability of the scan driver.

Also, the scan driver according to example embodiments may be directly attached to a chassis base via the first film 20 and/or the second film 30. Since both the first and second films 20 and 30 may exhibit insulating properties and may enclose the scan IC 10, i.e., first and second films 20 and 30 may be attached to and overlap the two opposite surfaces of the scan IC 10, the first and second films 20 and 30 may function as heat dissipation sheets with respect to the scan IC 10. Therefore, positioning of the scan IC 10 between the first and second films 20 and 30 when being attached to a chassis base may form a radiating heat system. The implementation of a general radiating heat system for radiating heat of the scan driver, e.g., dissipation of heat generated in the scan IC 10, may be easy, thereby making it possible to reduce manufacturing costs of the scan driver since costs required for installing a separate radiating heat system may be eliminated or substantially minimized as compared to a scan driver including a single film on a scan IC on a scan buffer board.

FIG. 3 illustrates a block diagram of a plasma display device using a scan driver according to example embodiments.

Referring to FIG. 3, a plasma display device may include a panel unit 100 in which at least several tens to several millions of cells may be arranged in a matrix pattern, and a driving unit driving the panel unit 100.

The panel unit 100 may include a pair of substrates opposite to each other, a barrier rib disposed between the substrates and partitioning a discharge space, an electrode group disposed between the pair of substrates and generating discharge in the discharge space, and a phosphor emitting light by the discharge.

The substrates described above may include glass substrates. The electrode group may be made of conductive material. The electrode group may include a scan electrode and a sustain electrode. For example, each of the scan and sustain electrodes may include a transparent electrode and a respective bus electrode, e.g., the bus electrodes may be made of material having lower electrical resistance than the transparent electrode and may not react with a dielectric. For example, the transparent electrode may be made of at least one of ITO, SnO₂, ZnO, CdSnO, and a combination thereof. The bus electrode may be made of, e.g., gold (Au) and/or silver (Ag). The discharge space may be injected with an inert gas, e.g., one or more of helium (He), xenon (Xe), neon (Ne), and so forth.

The driving unit may include a Y-driving unit 210 driving a plurality of scan electrodes Y1, Y2, Y3, . . . , Yn-1, and Yn, a X-driving unit 220 driving a plurality of sustain electrodes X1, X2, X3, . . . , X-1, and Xn, an address driving unit 230 driving a plurality of address electrodes A1, A2, A3, . . . , Am-1, and Am, and a control unit 240 generating and transmitting scan signals, sustain discharge signals, and address signals to each of driving unit 210, 220, and 230.

The control unit 240 may include a display data control unit 242 and a driving control unit 244. The display data control unit 242 may include a frame memory 243, and the driving control unit 244 may include a scan control unit 245 and a common control unit 246.

The control unit 240 may receive a clock signal CLK, a data signal DATA, a vertical synchronization signal V_{SYNC}, and a horizontal synchronization signal H_{SYNC} from the external, e.g., an external source.

The display data control unit 242 may store the data signal DATA for the internal frame memory 243 according to the clock signal CLK, and an address control signal corresponding thereto for the address driving unit 230.

The driving control unit 244 may process the vertical synchronization signal V_{SYNC} and the horizontal synchronization signal H_{SYNC}. The scan control unit 245 may generate signals controlling a scan driving unit 212, and the common control unit 246 may generate signals controlling a Y-common driving unit 214 and an X-driving unit 24.

The address driving unit 230 may process the address control signal of the display data control unit 242 and may apply display data signals corresponding to an address stage to the address electrodes A1, A2, . . . , Am-1, and Am of the panel unit 100.

The Y-driving unit 210 may include the scan driving unit 212 and the Y-common driving unit 214. The scan driving unit 212 may apply the scan driving signals corresponding to the address stage to each of the scan electro des Y1, Y2, . . . , Yn-1, and Yn according to the control signal of the scan control unit 245. The Y-common driving unit 214 may simultaneously apply the common driving signals to the scan electrodes Y1, Y2, . . . , Yn-1, and Yn according to the control signal of the common control unit 246 in the sustain discharge stage.

The Y-driving unit 210 according to example embodiments may be implemented as a scan driver described previously with reference to FIGS. 1 and 2A-2B. For example, the Y-driving unit 210 may include the scan IC 10, the first film 20, and the second film 30 described previously with reference to FIGS. 1 and 2A-2B. According to example embodiments, part of or all of the Y-driving unit 210 may be implemented as the scan driver.

The X-driving unit 220 may simultaneously apply the common driving signals to the sustain electrodes X1, X2, . . . , Xn-1, and Xn according to the control signal of the common control unit 246 in the sustain discharge stage.

The plasma display device described above may be driven by dividing one frame into a plurality of sub-fields. Each sub-field may include a reset period, an address period, and a sustain period. The reset period is a period to initialize the state of each cell so that an addressing operation may be smoothly performed in the cell. The address period is a period to select one cell to be turned on and the other cell not to be turned on and to accumulate wall charge on the cell to be turned on. The sustain period is a period to perform discharge for displaying an image on the cell to be turned on.

FIG. 4 illustrates a partial cross-sectional view of a scan driver attached to a plasma display device according to example embodiments.

Referring to FIG. 4, a plasma display device may include the panel unit 100 with an optical filter 110 attached thereto, a chassis base 120 having a first surface affixed to the panel unit 100, a scan driver 210a contacting a second surface of the chassis base 120 and affixed thereto, and cases 130a and 130b accommodating the panel unit 100, the chassis base 120, and the scan driver 210a. The panel unit 100 may be positioned between the optical filter 110 and the chassis base 120. The first and second surfaces of the chassis base 120 may be opposite each other, so the chassis base 120 may be between the panel display 100 and the scan driver 210a.

The scan driver 210a may be the scan driver described previously with reference to FIG. 1, and may be used as the Y-driving unit 210 described previously with reference to FIG. 3. The scan driver 210a may include the scan IC 10, the first film 20, the second film 30, and the passivation layer 40, described previously with reference to FIGS. 1 and 2A-2B. For example, the scan driver 210a may be attached to the chassis base 120 via either of the first and second films 20 and 30, e.g., the second film 30 of the scan driver 210a may be directly attached to the second surface of the chassis base 120.

The scan driver 210a may be coupled to a scan electrode and/or a sustain electrode of the panel unit 100 through a separate wire 218. At this time, the first film 20 and the second film 30 may be coupled to each other through a connector 216. The connector 216 may have its own conductive pattern, and may electrically couple wire patterns performing a same function in the first film 20 and the second film 30.

According to example embodiments, when reference voltage of the scan IC 10 is abruptly changed during the sustain period of the plasma display device, the scan driver 210a may generate less noise, e.g., as compared to a scan driver having a single film, and may lower a temperature of the scan driver 210a, thereby making it possible to prevent or substantially minimize malfunction of the system and improve stability thereof. Furthermore, formation of the scan driver 210a according to example embodiments may facilitate omission of a separate scan buffer board from the driving unit of the plasma display device, thereby making it possible to simplify the scan driving integrated circuit and to reduce manufacturing costs thereof.

Example embodiments may provide one or more of the following effects.

First, reference potential of a scan IC may be sufficiently secured in a smaller area as compared to a scan driving system with a separate scan buffer board for supporting a wider reference potential pattern, making it possible to prevent malfunction of the system.

Secondly, the signal and output of the scan IC may be shielded using the reference potential, making it possible to obtain EMI shielding effects.

Thirdly, the scan IC may adopt a COF or TCP type, making it possible to reduce costs as compared to an existing PCB type.

Fourth, an input signal pattern and a reference potential pattern may be selectively designed on two films, making it possible to improve the degree of freedom in designing the input signal pattern and the reference potential pattern.

Fifth, the scan IC may be easily attached directly to a radiating heat system, e.g., a chassis base.

Sixth, a scan driver structure may be simplified, making it possible to reduce costs rendered in manufacturing the scan driver and a plasma display device using the same.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A scan driver, comprising:
a scan driving integrated circuit;
a first film on a first surface of the scan driving integrated circuit, the first film including at least one first wire adapted to provide reference potential to the scan driving integrated circuit; and
a second film on a second surface of the scan driving integrated circuit, the second surface of the scan driving integrated circuit being opposite the first surface, and the second film including at least one second wire adapted to transfer input and output signals.

2. The scan driver as claimed in claim 1, wherein the first film and the second film are coupled to each other through a connector.

3. The scan driver as claimed in claim 1, further comprising a passivation layer between the first film and the second film, the passivation layer surrounding the scan driving integrated circuit.

4. The scan driver as claimed in claim 1, wherein the first and second wires are facing each other.

5. The scan driver as claimed in claim 1, wherein the scan driver includes a plurality of the second wires, the first wire overlapping the plurality of second wires.

6. The scan driver as claimed in claim 1, wherein a width of the first wire equals at least half a width of the first film, the widths of the first wire and first film being measured along a direction substantially perpendicular to a longitudinal direction of the first film.

7. The scan driver as claimed in claim 1, further comprising at least one third wire on the second film, the third wire being adapted to provide reference potential to the scan driving integrated circuit.

8. A plasma display device, comprising:
a panel unit, the panel unit including a pair of substrates opposite to each other, a scan electrode and an address electrode disposed between the substrates and generating discharge in a discharge space between the substrates, and a phosphor emitting light due to the discharge; and
a scan driver connected to the panel unit, the scan driver adapted to drive the scan electrode and the sustain electrode, the scan driver including:
a scan driving integrated circuit;
a first film on a first surface of the scan driving integrated circuit, the first film including at least one first wire adapted to provide a reference potential to the scan driving integrated circuit; and
a second film on a second surface of the scan driving integrated circuit, the second surface of the scan driving integrated circuit being opposite the first surface, and the second film including at least one second wire adapted to transfer input and output signals.

9. The plasma display device as claimed in claim 8, further comprising:
a chassis base between the panel unit and the driving unit, any one of the first film and the second film of the scan driver being disposed to contact the chassis base.

10. The plasma display device as claimed in claim 9, wherein the film of the scan driver contacting the chassis base extends on the chassis base and in parallel thereto.

11. The plasma display device as claimed in claim 9, wherein the film of the scan driver contacting the chassis base is attached to and overlaps a surface of the scan driving integrated circuit, the surface being one of two opposite surfaces of the scan driving integrated circuit.

12. The plasma display device as claimed in claim 8, further comprising:
a passivation layer surrounding the scan driving integrated circuit between the first film and the second film.

13. The plasma display device as claimed in claim 8, wherein a width of the first wire of the scan driver equals at least half a width of the first film of the scan driver, the widths of the first wire and first film being measured along a direction substantially perpendicular to a longitudinal direction of the first film.

14. The plasma display device as claimed in claim 8, further comprising at least one third wire on the second film scan driver, the third wire being adapted to provide reference potential to the scan driving integrated circuit.

15. The plasma display device as claimed in claim 8, wherein the second film is longer than the first film.

16. The plasma display device as claimed in claim 15, wherein the first film is not overlapping the second wire on the second film.
